(19) United States
(12) Patent Application Publication
(10) Pub. No.: US 2025/0196536 A1
(43) Pub. Date: Jun. 19, 2025

(54) VEHICLE ASSEMBLIES AND RELATED KITS AND METHODS

(71) Applicant: Bruce Berkan, Calgary (CA)

(72) Inventor: Bruce Berkan, Calgary (CA)

(21) Appl. No.: 18/986,019

(22) Filed: Dec. 18, 2024

Related U.S. Application Data
(60) Provisional application No. 63/611,916, filed on Dec. 19, 2023.

(51) Int. Cl. B60B 39/12

(52) U.S. Cl. CPC B60B 39/12

(57) ABSTRACT

Vehicle assemblies for providing traction to vehicles off-road are provided. The vehicle assembly may comprise: an elongated body having a first end and a second end; a mounting assembly comprising: a mounting base connectable to an underside of a vehicle; and a mounting track extending from the mounting base, the mounting track supporting the first end of the elongated body; an activatable release mechanism connectable to the underside of the vehicle, the release mechanism releasably engaging the second end of the elongated body; and wherein activation of the release mechanism releases the second end of the elongated body, and wherein release of the second end allows the first end to slide out of the mounting track to release the elongated body from the vehicle. Related kits and methods are also provided.

### CROSS REFERENCE TO RELATED APPLICATION

The present disclosure claims priority to U.S. Provisional Patent Application No. 63/611,916, filed Dec. 19, 2023, the entire content of which is herein incorporated by reference.

### TECHNICAL FIELD

The present disclosure relates to vehicle components and accessories. More particularly, the present disclosure relates to vehicle assemblies for deploying sand ladders and related kits and methods.

### BACKGROUND

Vehicles can become stuck in soft and uneven terrain, such as dirt, mud, sand, ice, and snow. Sand ladders, also referred to as traction plates or traction tracks, can be positioned adjacent to a vehicle wheel to provide a hard surface for the wheel to roll onto and allow the vehicle to regain traction. Sand ladders are typically long metal or composite panels that have holes or grooves therein that assist in providing traction. Two sand ladders may be used per vehicle, one for each side.

Conventional sand ladders are stored within or outside of the vehicle and are removed when the vehicle becomes stuck and positioned adjacent to the vehicle tires. However, sand ladders can be bulky and may be difficult to fit in or on some vehicles. In addition, the sand ladders are generally deployed after the vehicle becomes stuck and, depending on how deep the tires are embedded in the mud, snow, etc., it may still be difficult to get the vehicle to roll onto the sand ladders. Deploying the sand ladders also requires the driver or a passenger to get out of the vehicle, remove the sand ladders, and position the sand ladders adjacent to the vehicle tires. Thus, it can take significant time and intense physical effort before the vehicle can gain traction and start moving again.

### SUMMARY

In one aspect, there is provided a vehicle assembly comprising: an elongated body having a first end and a second end; a mounting assembly comprising: a mounting base connectable to an underside of a vehicle; and a mounting track extending from the mounting base, the mounting track supporting the first end of the elongated body; and an activatable release mechanism connectable to the underside of the vehicle, the release mechanism releasably engaging the second end of the elongated body; wherein activation of the release mechanism releases the second end of the elongated body, and wherein release of the second end allows the first end to slide out of the mounting track to release the elongated body from the vehicle.

In some embodiments, the release mechanism comprises a retractable element, the retractable element moveable between an extended position and a retracted position.

In some embodiments, the release mechanism comprises a solenoid and the retractable element comprises a moveable magnetic plunger within a coiled wire, the plunger being moveable by application of electrical current to the coiled wire.

In some embodiments, the release mechanism further comprises a support block coupled to a distal end of the plunger.

In some embodiments, the release mechanism comprises a cable release and the retractable element comprises a retractable cable coupled to a support block.

In some embodiments, the vehicle assembly further comprises: a secondary support block positioned below the support block; and a rear mount structure slidably engaged with the support block.

In some embodiments, the retractable element comprises a tab coupled to a moveable plunger therebelow and a rotatable cylindrical rod extending downwards from the tab adjacent to the moveable plunger, wherein linear movement of the moveable plunger rotates the rotatable cylindrical rod, thereby rotating the tab.

In some embodiments, the release mechanism comprises a pneumatic air cylinder and the retractable element comprises a moveable piston and a piston rod within a barrel, the piston and piston rod moveable by application of compressed air into the barrel.

In some embodiments, the pneumatic air cylinder is positioned parallel to the elongated body such that the piston rod extends below the elongated body.

In some embodiments, the vehicle assembly further comprises a push mechanism, wherein the push mechanism comprises a pneumatic air cylinder that is positioned above and perpendicular to the elongated body such that the piston rod extends downwards towards the elongated body.

In some embodiments, the elongated body comprises a recessed portion that at least partially receives the release mechanism.

In some embodiments, the vehicle assembly further comprises a first flange at the first end of the elongated body, the first flange being perpendicular to the elongated body and extending downwards therefrom.

In some embodiments, the vehicle assembly further comprises a second flange at the second end of the elongated body, the second flange being perpendicular to the elongated body and extending downwards therefrom.

In some embodiments, the elongated body comprises a horizontal portion and one or more V-shaped ridges extending downwards from the horizontal portion.

In some embodiments, the vehicle assembly further comprises a switch electrically connected to the release mechanism and a power source.

In some embodiments, the switch is positionable in the interior of the vehicle.

In another aspect, there is provided a kit comprising: a first vehicle assembly and a second vehicle assembly, wherein each of the first and second assemblies are an embodiment of the vehicle assembly disclosed herein; and a switch electrically connectable to the respective release mechanisms of the first vehicle assembly and the second vehicle assembly.

In some embodiments, the kit further comprises at least one pin or handle for engaging the elongated body of each of the first and second vehicle assemblies.

In another aspect, there is provided a method for assembling a vehicle assembly, comprising: providing an elongated body with a first end and a second end; and positioning the elongated body between a mounting assembly at the first end and an activatable release mechanism at the second end.

In some embodiments, the release mechanism comprises a retractable element, the retractable element moveable between an extended position and a retracted position; and wherein the second end of the elongated body is positioned on the retractable element in the extended position.

Other aspects and features of the present disclosure will become apparent, to those ordinarily skilled in the art, upon review of the following description of specific embodiments of the disclosure.

### BRIEF DESCRIPTION OF THE DRAWINGS

Some aspects of the disclosure will now be described in greater detail with reference to the accompanying drawings. In the drawings:

FIG. 1 is a perspective view of an example vehicle assembly, according to some embodiments;

FIGS. 2A and 2B are schematic end views of an elongated body of the vehicle assembly of FIG. 1, showing alternative profiles;

FIG. 2C is a partial schematic side view of the elongated body of FIGS. 2A and 2B;

FIG. 2D is a schematic end view of the elongated body of FIG. 2B, shown engaging a retention mechanism;

FIG. 2E is a perspective view of an alignment tab of FIGS. 2A, 2B, and 2D;

FIGS. 3A and 3B are enlarged, partial side view schematics of the vehicle assembly of FIG. 1 showing a release mechanism in a first position and a second position, respectively;

FIGS. 4A and 4B are enlarged, partial side view schematics of the vehicle assembly of FIG. 1 showing an alternative release mechanism in a first position and a second position, respectively;

FIGS. 5A and 5B are enlarged, partial side view schematics of the vehicle assembly of FIG. 1 showing another alternative release mechanism in a first position and a second position, respectively;

FIGS. 6A and 6B are enlarged, partial top view schematics of the vehicle assembly of FIG. 1 showing another alternative release mechanism in a first position and a second position, respectively;

FIG. 6C is a side view schematic of the release mechanism of FIGS. 6A and 6B;

FIG. 7A is an enlarged, partial side view schematic of the vehicle assembly of FIG. 1 showing an alternative release mechanism utilizing an air cylinder in a horizontal configuration;

FIG. 7B is an enlarged, partial side view schematic of a push mechanism utilizing an air cylinder in a vertical configuration;

FIG. 8A-8C are schematic side view schematics of the vehicle assembly of FIG. 1 shown attached to a vehicle at various stages of deployment; and

FIG. 9 is a flowchart of an example method for assembling a vehicle assembly, according to some embodiments.

### DETAILED DESCRIPTION

Generally, the present disclosure provides a vehicle assembly. The vehicle assembly may also be referred to as a self-deploying sand ladder. Also provided are related kits and methods.

As used herein and in the appended claims, the singular forms of “a”, “an” and “the” include plural referents unless the context clearly dictates otherwise.

As used herein, the terms “top” and “bottom”, “upper” and “lower”, “upward” and “downward” and the like refer to the typical orientation of the vehicle assembly during normal operation; however, a person skilled in the art will recognize that these are relative terms that are used for ease of description only and do not limit the orientation of the vehicle assemblies described herein.

As used herein, “vehicle” is intended to be inclusive of any self-propelled land vehicle including, but not limited to, cars, trucks, sports utility vehicles, vans, buses, off-road vehicles, recreational vehicles, and heavy construction equipment. Most vehicles have four wheels, two on each side, but the assemblies herein may also be applicable to other types of vehicles with a different number and/or arrangement of wheels.

As used herein, “user” refers to any user of the vehicle assemblies disclosed herein. The user may be the driver of the vehicle or another passenger.

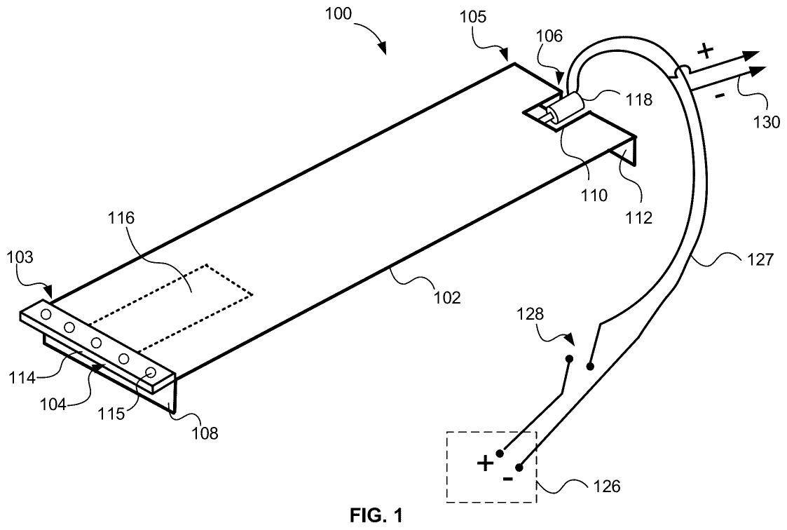

An example vehicle assembly 100 will be discussed with reference to FIG. 1. The vehicle assembly 100 in this embodiment comprises an elongated body 102, a mounting assembly 104, and an activatable release mechanism 106.

The elongated body 102 may also be referred to as a “sand ladder”, “traction track”, “traction plate”, or the like. The elongated body 102 may be a relatively thin and flat piece of metal, composite, or any other suitable material. As one non-limiting example, the elongated body 102 may be made of 3/16″ 6061 T6 aluminum. Alternatively, the elongated body 102 could be made of a biodegradable material such as a wood fiber. In this embodiment, the elongated body 102 is approximately rectangular. In other embodiments, the elongated body 102 may be a rounded rectangle, an elongated oval shape, or any other suitable shape. In some embodiments, the elongated body 102 may comprise a plurality of holes, grooves, slots, or the like (not shown) to assist in providing traction for vehicle tires. The length of the elongated body 102 may vary depending on the type of vehicle with which it will be used. In some embodiments, the length may be approximately 8 inches less than front to back tire-to-tire length of the vehicle at the elevation at which the elongated body 102 is mounted. In other embodiments, the elongated body 102 may be any other suitable length.

The elongated body 102 has a first end 103 and a second end 105. The first end 103 may be configured to engage the mounting assembly 104 and the second end 105 may be configured to engage the release mechanism 106. In this embodiment, the elongated body 102 comprises a first vertical flange 108 at its first end 103. The first vertical flange 108 may be configured to help secure the elongated body 102 in the ground when the elongated body 102 is released from the assembly 100, as discussed in more detail below. The first vertical flange 108 may comprise a relatively flat, thin bar or panel that extends approximately perpendicular to the elongated body 102. In normal operation, when the elongated body 102 is arranged horizontally, the flange 108 may extend approximately vertically downwards. The flange 108 may be integral with the elongated body 102 or may be a separate part coupled thereto. The first vertical flange 108 may comprise a slot extending therethrough (not shown) that may receive a mounting track 116 of the mounting assembly 104, as discussed in more detail below. In other embodiments, the flange 108 may be omitted and the first end 103 of the elongated body 102 may comprise a flat edge that rests atop the mounting track 116.

The elongated body 102 in this embodiment comprises a recessed portion 110 at its second end 105. The recessed portion 110 is dimensioned to at least partially receive the release mechanism 106. The recessed portion 110 may be approximately rectangular in shape or any other suitable shape. In other embodiments, the recessed portion 110 may be omitted and the elongated body 102 may be shortened such that the second end 105 terminates proximate the release mechanism 106 (e.g. the second end 105 terminates at the location of the recessed portion 110 in FIG. 1).

In this embodiment, a second vertical flange 112 is provided at the second end 105 of the elongated body 102. The second vertical flange 112 may be configured to help secure the elongated body 102 in the ground when the elongated body 102 is released from the assembly 100, as discussed in more detail below. The second flange 112 may be similar to the first flange 108 and may be a relatively flat, thin bar or panel that extends approximately perpendicular to the elongated body 102. The second flange 112 may be split into two sections, with a respective section on either side of the recessed portion 110 of the body 102. In normal operation, when the elongated body 102 is arranged horizontally, the flange 112 will extend approximately vertically downwards. The flange 112 may be integral with the elongated body 102 or may be a separate part coupled thereto. In other embodiments, the flange 112 may be omitted.

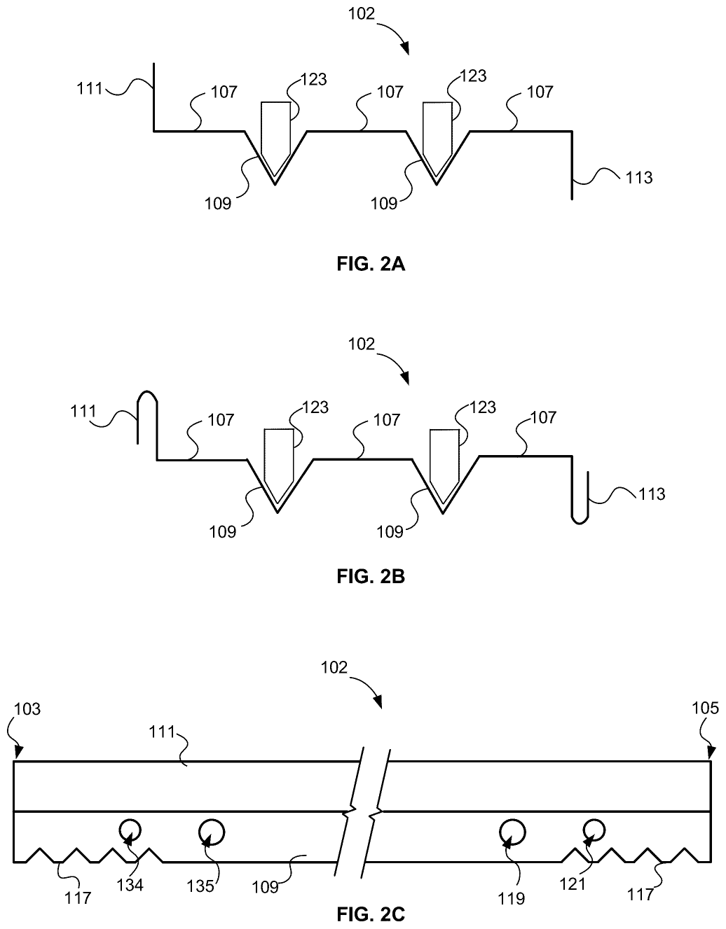

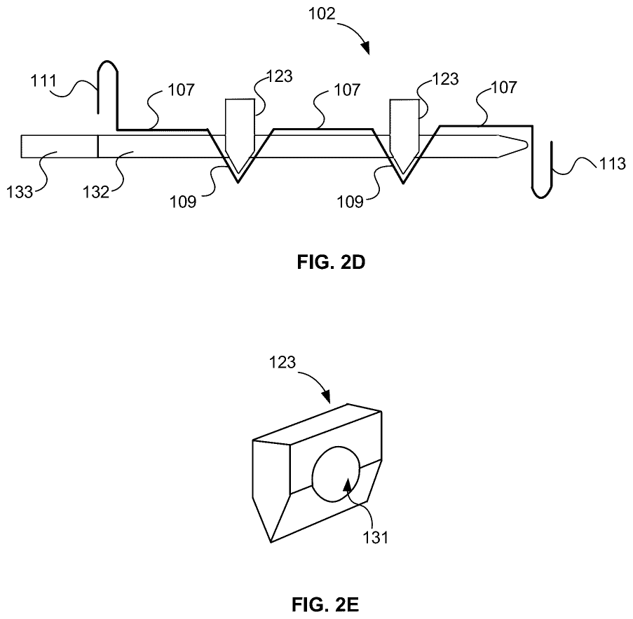

In FIG. 1, the elongated body 102 is a relatively flat panel extending between flanges 108 and 112. In other embodiments, the body 102 may have additional features to aid in securing the body 102 to the ground when deployed. FIGS. 2A and 2B are schematic end views of the elongated body 102, showing two possible alternative profiles for the elongated body 102. Note that the flanges 108 and 112 are omitted in FIGS. 2A and 2B for simplicity.

Referring to FIGS. 2A and 2B, the elongated body 102 may have a horizontal portions 107 and one or more V-shaped ridges 109. In this embodiment, the elongated body 102 has two V-shaped ridges 109. In other embodiments, the number of V-shaped ridges 109 may vary. The V-shaped ridges 109 extend downwards from the horizontal portion 107 and may help to secure the elongated body 102 in the ground when the elongated body 102 is released from the assembly 100. In addition, the ridges 109 may also be used to help align the body 102 on the underside of the vehicle. As shown in FIGS. 2A and 2B, an optional pair of tabs 123 may be provided that extend downwards from the release mechanism 106 (not visible in FIGS. 2A and 2B) and fit within the V-shaped ridges 109. The presence of the tabs 123 within the ridges 109 self-aligns the body 102 and prevents it from shifting from side to side while the vehicle is in motion. FIG. 2E is a perspective view of an example tab 123. Each tab 123 may include a hole 131 therethrough that aligns with the passageways 119, 121 in the ridges 109 discussed below.

The elongated body 102 may further comprise a first side edge 111 and a second side edge 113. In this embodiment, the first side edge 111 extends upwards and the second side edge 113 extends downwards. In the embodiment in FIG. 2A, the first and second side edges 111 and 113 are flat panels. In the embodiment in FIG. 2B, the first and second side edges 111 and 113 are curved back on themselves to form an approximate U-shape. The body 102 may be positioned on the vehicle such that the first side edge 111 faces outwards (and therefore extends upwards along the side of the vehicle) and the second side edge 113 faces inwards. The upwardly extending first side edge 111 may therefore help to prevent rocks and other debris from entering between the body 102 and the underside of the vehicle (similar to a rock slider), whereas the second side edge 113 may help with anchoring the body 102 to the ground when deployed.

FIG. 2C is a partial schematic side view of the elongated body 102 with the profile of FIG. 2A. Note that the flanges 108 and 112 are omitted from FIG. 2C for simplicity. In some embodiments, a plurality of teeth 117 may be provided at the bottom apex of each V-shaped ridge 109. A similar plurality of teeth 117 may be provided at the bottom of the second side edge 113 (not visible in FIG. 2C). The teeth 117 may help to further secure the elongated body 102 to the ground once deployed. As shown in FIG. 2C, a group of the teeth 117 along the V-shaped ridges 109 (and the second side edge 113) may be provided close to the first end 103 of the body 102 and another group of teeth 117 provided close to the second end 105 of the body 102 such that there are few or no teeth in the middle of the elongated body 102. Spacing the teeth may help to minimize the reduction of bending strength of the elongated body 102. Although one arrangement of teeth 117 is shown in FIG. 2C, it will be understood that other teeth shapes, sizes, and spacing are possible and embodiments are not limited to the arrangement shown in FIG. 2C.

Each V-shaped ridge 109 may further comprise one or more holes therethrough. A pair of aligned holes may be provided on each side of each “V” to provide an overall passageway through both of the ridges 109. As shown in FIG. 2C, in this embodiment, a first passageway 119 and a second passageway 121 may be provided that extend through the two V-shaped ridges 109 (formed by four aligned holes total) proximate to the second end 105. The first passageway 119 may be used for lifting the body 102 and the second passageway 121 may be used for a retention or loading mechanism to supplement the release mechanism 106. As can be seen in FIG. 2C, in this embodiment, the first end 103 is a mirror image of the second end 105 and a corresponding third and fourth passageway 134 and 135 are provided proximate the first end 103 to receive a “U”-shaped rod as discussed below.

As shown in FIG. 2D, in some embodiments, the retention mechanism comprises a horizontal pin 132. The pin 132 may be a cylindrical rod made of metal (e.g. aluminum), for example. The pin 132 may have a tapered tip on one end to facilitate alignment with the holes in the body 102 and a knurled surface (not visible) at the opposite end to facilitate gripping by the user. In other embodiments, the pin 132 may be any other suitable shape and material. When the assembly 100 is first installed on a vehicle, the pin 132 may extend through the second passageway 121 to hold the elongated body 102 in place. When the user desires to take the vehicle off-road (and thus deployment of the elongated body 102 may be needed), the pin 132 may be pulled out of the passageway 121 and removed. Optionally, the pin may have a flag or some other label on it indicating that it is for “off-road use only” to prevent the body 102 from being deployed in inappropriate situations such as city driving. The pin 132 could also be configured to lock in place to preclude loss, unauthorized removal, and/or theft. A second pin 133 may extend through the first passageway 119A to function as a loading handle to allow the user to pick up the elongated body 102 after it has been deployed and reload the elongated body 102 into the mounting assembly 104. The second pin 133 may be several inches longer than the first pin 132 to allow it to be gripped by both hands. The second pin 133 may have a tapered tip (not visible) at one end and a knurled surface (not visible) at the other end to facilitate gripping.

The third and fourth passageways 134, 135 may be used to receive a “U”-shaped rod (not shown) that could be made of a similar material to the pin 132. The rod may be used to link the elongated body 102 to another elongated body to allow the vehicle to “leapfrog” over difficult terrain as discussed below. The U-shaped rod may have tapered ends similar to the pin 132 and may also have a knurled center section to facilitate gripping.

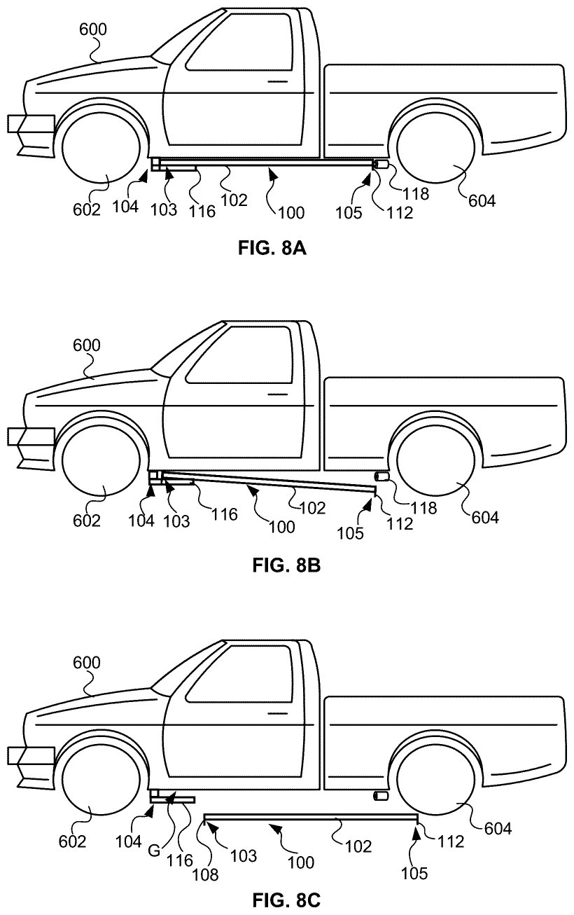

Referring again to FIG. 1, the mounting assembly 104 is configured to releasably mount the elongated body 102 to the underside of a vehicle (e.g., the vehicle 600 of FIGS. 8A-8C). The mounting assembly 104 in this embodiment comprises a mounting base 114 and a mounting track 116. The mounting track 116 is shown in FIG. 1 in dashed lines as it would not normally be visible through the body 102. The mounting base 114 is connectable to the underside of the vehicle. In this embodiment, the mounting base 114 is connectable to the underside of the vehicle via a series of bolts 115. In other embodiments, the mounting base 114 may be connectable to the vehicle by any other suitable coupling means. The mounting base 114 may be coupled directly to the underside of the vehicle or may be coupled to another component, such as a bracket or spacer, which is then coupled to the vehicle.

The mounting track 116 extends from the mounting base 114 approximately parallel to the underside of the vehicle. In some embodiments, the mounting track 116 curves downwards to facilitate release and reloading of the elongated body 102. The mounting track 116 is configured to support the first end 103 of the elongated body 102. The mounting track 116 in this embodiment comprises a flat (linear) plate that extends through the slot in the first vertical flange 108 to support the first end 103 of the elongated body 102. In embodiments in which the flange 108 is omitted, the first end 103 of the elongated body 102 may rest atop of the mounting track 116. When the assembly 100 is installed on a vehicle, the mounting track 116 may be spaced from the underside of the vehicle such that a gap is provided between the vehicle and the mounting track 116 for the elongated body 102 to slide into. An example gap G can be seen in FIG. 8C with the vehicle 600. In some embodiments, the mounting track 116 may be angled toward the outside of the vehicle it order to position the body 102 farther outwards, as may be required for vehicles that have wheels that extend farther out from the vehicle body. In some embodiments, the vehicle assembly 100 may further comprise a second mounting track (not shown), similar to the mounting track 116, that could be added to support the second end 105 of the body 102. The second mounting track may function to angle the deployment of the second end 105 of the body 102 to match the first end 103.

The length of the mounting track 116 may be selected to be only a portion of the length of the elongated body 102 to facilitate the first end 103 of the body 102 sliding out of the mounting track 116 when the second end 105 is released. For example, the length of the mounting track 116 may be between about 10% and 30% of the length of the elongated body 102. The length of the mounting track 116 may vary depending on the length of the elongated body 102, which may be based on the type and size of vehicle as discussed above. As one non-limiting example, the mounting track 116 may be approximately 8 inches for vehicle assemblies 100 configured for sports utility vehicles. In other embodiments, the mounting track 116 may be any other suitable length. In this embodiment, the width of the mounting track 116 is less than the width of the body 102. In other embodiments, the mounting track 116 may be the same width as the body 102 or slightly wider.

In other embodiments, the mounting track 116 may comprise rails for the first end 103 of the elongated body 102 to slide into or any other suitable structure for engaging the first end 103 of the elongated body 102.

The release mechanism 106 is configured to releasably engage the second end 105 of the elongated body 102. The release mechanism 106 may comprise a retractable element that is moveable between an extended position and a retracted position. The release mechanism 106 thereby releasably secures the second end 105 of the elongated body 102 to the underside of the vehicle and releases the second end 105 when activated (i.e. when the retractable element is retracted).

In this embodiment, the release mechanism 106 comprises a solenoid 118. The solenoid 118 may be positioned in the recessed portion 110 of the elongated body 102 at its second end 105.

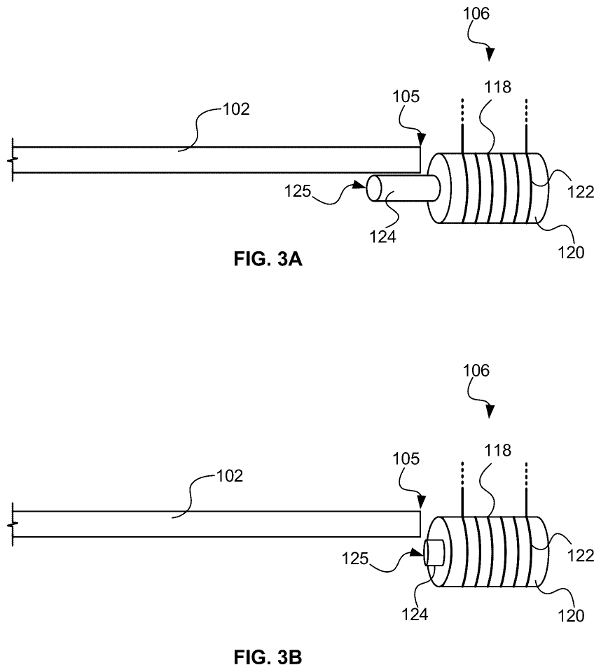

The solenoid 118 will be discussed in more detail with reference to FIGS. 3A and 3B. The solenoid 118 comprises a housing 120, a coiled wire 122, and a moveable spindle/plunger 124. Note that the solenoid 118 in FIGS. 3A and 3B is not to scale and the housing 120 is shown as transparent for illustrative purposes only.

The housing 120 is connectable to the underside of the vehicle, either directly or indirectly. For example, a bracket may be installed on the underside of the vehicle and the housing 120 may be positioned on the bracket. In other embodiments, the housing 120 can be connected to the vehicle by any other suitable means. The housing 120 is configured to house the coiled wire 122 and the plunger 124. The housing 120 may be approximately cylindrical, rectangular, or any other suitable shape and may be made of any suitable non-conductive and waterproof material.

The coiled wire 122 is housed within the housing 120 and surrounds the plunger 124. The coiled wire 122 is electromagnetically conductive and configured to generate a magnetic field when electrical current flows therethrough. The coiled wire 122 may comprise a tightly wound metal wire made of copper or any other conductive suitable material.

The plunger 124 is configured to move in and out of the housing 120 based on the presence or absence of the magnetic field generated by the coiled wire 122. The plunger 124 is made of a suitable magnetic material such as iron. The plunger 124 may be an approximately cylindrical rod or any other suitable shape. The plunger 124 has a proximal end disposed within the housing 120 (not visible) and a distal end 125 that projects out of the housing 120.

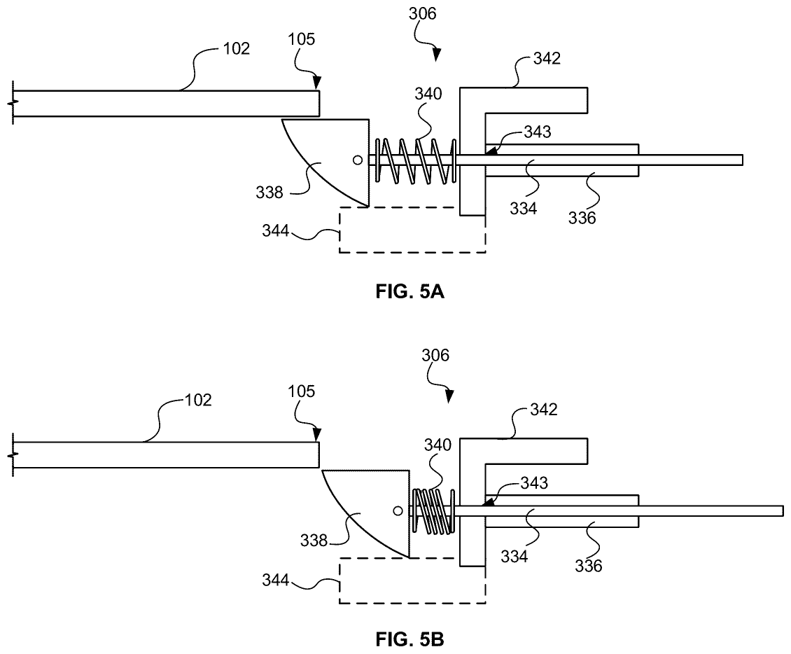

The plunger 124 has a first (extended) position as shown in FIG. 3A where the distal end 125 extends outwards from the housing 120 and a second (retracted) position as shown in FIG. 3B where the distal end 125 is close to the housing 120. When there is no electrical current being supplied to the coiled wire 122 (and thus there is no magnetic field), the plunger 124 is in the extended position. A spring (not shown) may bias the plunger 124 in the extended position. The spring may be disposed within the housing 120 or may be external to the housing 120 (similar to the spring 340 of FIGS. 5A and 5B, discussed below). As shown in FIG. 3A, in the extended position, the plunger 124 extends below and parallel to the body 102 and thus the recessed portion 110 of elongated body 102 sits atop plunger 124. The plunger 124 thereby holds the second end 105 of the body 102 close to the underside of the vehicle and approximately in line with the first end 103 of the body 102 that is supported by the mounting track 116.

When electrical current is supplied to the coiled wire 122 (thereby generating a magnetic field), the magnetic field draws the plunger 124 into the housing 120 into the retracted position and compresses the spring. As shown in FIG. 3B, in the retracted position, the plunger 124 is pulled away from the recessed portion 110 of the body 102 such that the body 102 is no longer supported by the plunger 124. The second end 105 of the body 102 is thus released.

Referring again to FIG. 1, the coiled wire 122 may be electrically connected to a power source 126 via wires 127. In some embodiments, the power source 126 is a battery, for example, a 12V battery. In some embodiments, the battery is the main battery for the vehicle. In other embodiments, the battery is a separate power source for the vehicle assembly 100. In other embodiments, the power source 126 may be any other suitable power source.

A switch 128 may be provided between the power source 126 and the coiled wire 122 of the solenoid 118. When the switch 128 is open, the solenoid 118 is inactive/deactivated i.e., no electrical current flows to the coiled wire 122 and the plunger 124 is in its extended position. When the switch 128 is closed, the solenoid 118 is activated, i.e., electrical current flows to the coiled wire 122 to generate a magnetic field and the plunger 124 is retracted.

The switch 128 is shown schematically in FIG. 1 but may be in the form of a flip switch, a capacitive touch switch, or another suitable switch device activatable by the user. In some embodiments, the switch 128 may be key activated. Optionally, the switch 128 may have a label or flag on it indicating that it is for “off-road use only” to prevent the vehicle assembly 100 from being deployed in inappropriate situations such as city driving. As another option, a warning could pop up from the elongated body 102 when it is deployed. In some embodiments, the switch 128 may be positioned in the interior of the vehicle (i.e., the cab) on the dash or at any other location accessible to the user. The switch 128 may be mountable to the dash for ready access. Alternatively, the switch 128 may be mountable to the exterior of the vehicle, for example on one of the side mirrors.

In some embodiments, the switch 128 is electrically connected to a solenoid of a second vehicle assembly (not shown). For example, as shown in FIG. 1, wires 130 may connect wires 127 to the second vehicle assembly. Thus, one vehicle assembly 100 can be installed on one side of the vehicle and another assembly 100 can be installed on the other side of the vehicle, with the switch 128 operable to control both assemblies. In other embodiments, each assembly 100 may be provided with its own independent switch. As another option, a single switch 128 and solenoid 118 could be used to activate a linkage (not shown) that deploys elongated bodies 102 on both sides of the vehicle.

Alternatively, or additionally, the vehicle assembly 100 may be automatically deployed without driver intervention. For example, release logic may be programmed into the vehicle's onboard computer such that wheel slip and surface speed are used to trigger activation of the release mechanism 106. In these embodiments, the switch 128 may be omitted or may be included only as a back-up.

In some embodiments, the release mechanism 106 may further comprise one or more additional solenoids (not shown) and/or other latching mechanisms. For example, it may be desirable to have one or more additional solenoids to help secure longer elongated bodies 102 configured for larger vehicles such as campers, trailers, or heavy trucks.

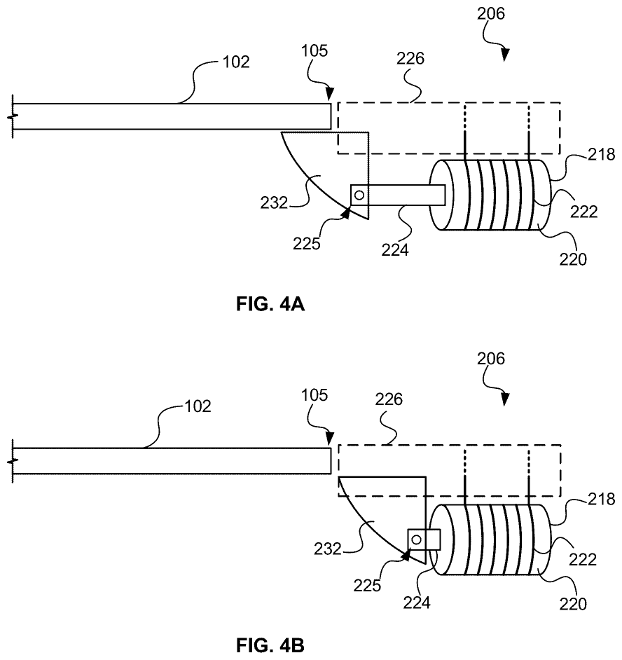

Other variations of the release mechanism 106 are possible. One example of an alternative release mechanism 206 will be discussed with reference to FIGS. 4A and 4B. The release mechanism 206 in this embodiment comprises a solenoid 218 and is mounted to the underside of the vehicle via a rear mount 226. The rear mount 226 is depicted in a simplified manner in FIGS. 4A-4B and it will be understood that the rear mount 226 may be any suitable structure such as various mounting brackets and the like. The solenoid 218 is similar to the solenoid 118 of the release mechanism 106 and comprises a housing 220, a coiled wire 222, a moveable spindle/plunger 224, and a spring (not shown). In this embodiment, the plunger 224 is coupled to a support block 232 via its distal end 225. The support block 232 is shown as transparent in FIGS. 4A and 4B for illustrative purposes only. The support block 232 may have a curved shape similar to a door latch. In other embodiments, the support block 232 may have any other suitable shape.

The solenoid 218 may function in a similar manner to the solenoid 118, as discussed above. The plunger 224 has a first (extended) position as shown in FIG. 4A and a second (retracted) position as shown in FIG. 4B. When the plunger 224 is in the extended position (FIG. 4A), the recessed portion 110 of the elongated body 102 may rest atop the support block 232. The support block 232 thereby provides a larger support for the elongated body 102 than just the plunger 224. When the plunger 224 is in the retracted position (FIG. 4B), the support block 232 is pulled away from the elongated body 102, thereby releasing the second end 105 of the elongated body 102.

When the vehicle assembly 100 with the release mechanism 206 is being assembled (or the elongated body 102 is being reloaded following deployment), the elongated body 102 may be pushed upwards against the support block 232, thereby causing the plunger 224 to retract into the housing 220. Once the elongated body 102 has been pushed past the support block 232 close to the underside of the vehicle, the spring of the solenoid 218 will move the plunger 224 back into its extended position such that the support block 232 supports the elongated body 102. In some embodiments, a secondary support under the support block 232 may be provided (not shown). The secondary support may be similar to the secondary support 344 in FIGS. 5A and 5B discussed below.

In some embodiments, the support block 232 has integral sliding surfaces (not shown) that engage with complementary surfaces in the rear mount 226. For example, the support block 232 may comprise ridges on its surface that slide within corresponding grooves on the surface of the rear mount 226. In these embodiments, the weight of the elongated body 102 would be supported by the rear mount 226 rather than the solenoid plunger 224 itself.

Another alternative release mechanism 306 will be discussed with reference to FIGS. 5A and 5B. The release mechanism 306 in this embodiment is a cable release mechanism rather than a solenoid-based mechanism.

The release mechanism 306 comprises a retractable inner cable 334, an outer cable 336, a support block 338, a spring 340, and a mount 342. The mount 342 is coupled to the outer cable 336 and is connectable to the underside of the vehicle. The inner cable 334 is positioned within the outer cable 336 and extends through a hole 343 in the mount 342. The inner cable 334 is connected to the support block 338 and the spring 340 is positioned around the inner cable 334 between the support block 338 and the mount 342.

The inner cable 334 is moveable with respect to the outer cable 336 between an extended position (shown in FIG. 5A) and a retracted position (shown in FIG. 5B). When the inner cable 334 is in the extended position (FIG. 5A), the elongated body 102 may rest atop the support block 338. The spring 340 may bias the support block 338 away from the mount 342, thereby securing the support block 338 below the elongated body 102.

When the inner cable 334 is pulled into the retracted position (FIG. 5B), the spring 340 is compressed between the support block 338 and the mount 342 and the support block 338 is pulled away from the elongated body 102. The second end 105 of the elongated body 102 may thereby be released. The inner cable 334 may be connected to a lever (not shown) operatable by the user to retract the inner cable 334. In some embodiments, the lever is mounted on the exterior of the vehicle (e.g., on one of the side mirrors). Mounting the lever on the exterior of the vehicle eliminates the need for the inner cable 334 to penetrate the vehicle body. In other embodiments, the inner cable 334 may be retracted by any other suitable mechanism.

When the vehicle assembly 100 with the release mechanism 306 is being assembled (or the elongated body 102 is being reloaded following deployment), the elongated body 102 may be pushed upwards against the support block 338, thereby compressing the spring 340 and causing the inner cable 334 to retract. Once the elongated body 102 has been pushed past the support block 338 to the underside of the vehicle, the spring 340 will bias the support block 338 away from the mount 342 such that the support block 338 supports the elongated body 102.

In some embodiments, a secondary support block 344 under the support block 338 may be provided. The secondary support block 344 be any suitable shape and may be coupled to the mount 342 or to a separate mounting structure. The secondary support block 344 may extend under the support block 338 but not under the body 102 to allow the body 102 to clear the secondary support block 344. The secondary support block 344 may be any suitable shape. The support block 338 may rest atop the secondary support block 344 or the secondary support block 344 may comprise a suitable ridge, rail, etc. to engage complementary sliding surfaces of the support block 338. Thus, in these embodiments, the weight of the body 102 may be supported by the secondary support block 344 which may help to avoid possible bending or damage to the inner cable 334 when it is extended. In other embodiments, the support block 338 may engage a rear mount structure (not shown), similar to the rear mount 226 of FIGS. 4A and 4B as discussed above, to help support the weight of the body 102.

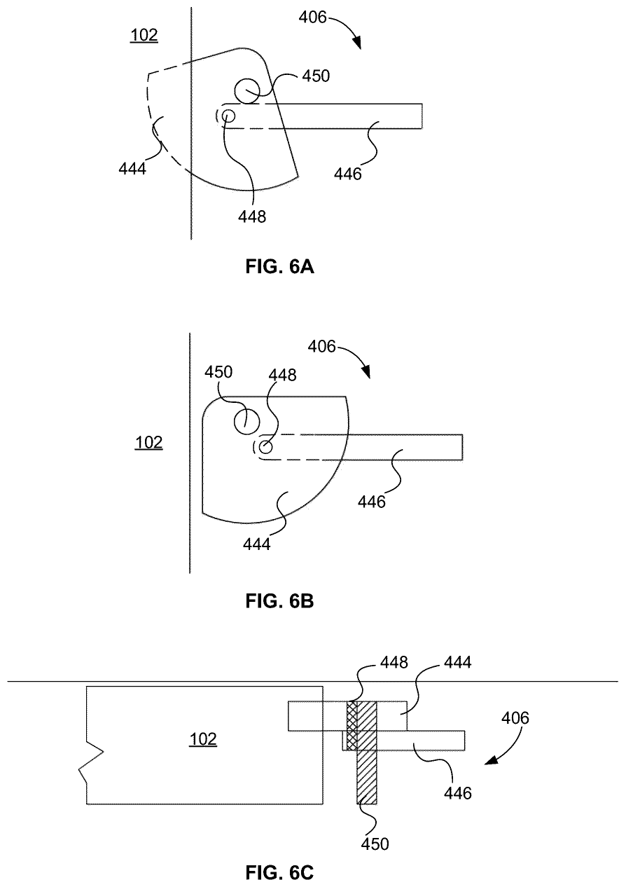

Another alternative release mechanism 406 will be discussed with reference to FIGS. 6A-6C.

The release mechanism 406 comprises a support tab 444 and a plunger 446. In this embodiment, the tab 444 is a rounded triangular shape. In other embodiments, the tab 444 may be any other suitable shape. The tab 444 is positioned above the plunger 456 and is coupled to the plunger 446 by a pin 448. The tab 444 is also coupled to a rotatable cylindrical rod 450 that extends through the tab 444 and is positioned adjacent to the plunger 446. The cylindrical rod 450 is rotatable with respect to the plunger 446.

The plunger 446 is movable between an extended position (shown in FIG. 6A) and a retracted position (shown in FIG. 6B). The linear movement of the plunger 446 between the extended and retracted positions (and vice versa) rotates the cylindrical rod 450, which thereby rotates the tab 444. When the plunger 446 is in the extended position (FIG. 6A), the tab 444 is rotated towards the elongated body 102 such that a portion of the tab 444 is below the elongated body 102 and thus the elongated body 102 rests atop the tab 444. In some embodiments, the tab 444 may be positioned below (or in an opening within) the central flat portion 107 of the elongated body 102 (between the two V-shaped ridges 109) in the profiles shown in FIGS. 2A and 2B. This position may help to center the elongated body 102 and prevent movement of the elongated body 102 side to side and back and forth when it is attached to the underside of the vehicle.

When the plunger 446 is in the retracted position (FIG. 6B), the tab 444 is rotated away from the elongated body 102 such that the tab 444 is no longer under the elongated body 102, thereby allowing the second end 105 of the elongated body 102 to be released.

To move the plunger 446 back and forth between the extended and retracted positions, the plunger 446 may be attached to a cable pull mechanism, a pneumatic air cylinder, a solenoid, an electrical mechanism, or any other suitable mechanism that would allow the plunger 446 to be moved back and forth. The mechanism may be attached to a suitable switch, lever, or other control mechanism operable by the user to release the elongated body 102 when desired.

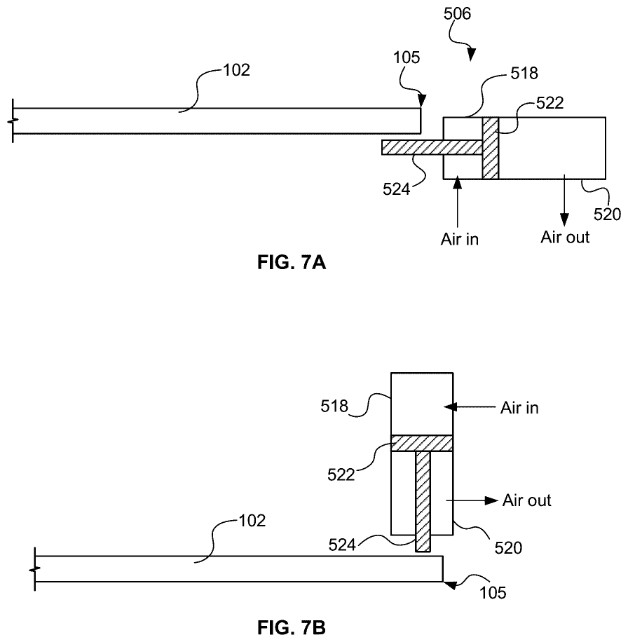

In other alternative embodiments, the release mechanism may comprise an activatable pneumatic air cylinder. FIG. 7A is a simplified schematic showing an example air cylinder-based release mechanism 506.

The release mechanism 506 comprises at least one air cylinder 518. The air cylinder 518 comprises a barrel 520 with a piston 522 coupled to a piston rod 524. The air cylinder 518 is in fluid communication with a compressed air source (not shown) via an actuatable control valve (not shown). The control valve may be electrically connected to a switch (not shown) similar to the switch 128 discussed above.

In the embodiment shown in FIG. 7A, the air cylinder 518 is positioned horizontally (i.e. parallel to the elongated body 102) with the piston rod 524 extending below the second end 105 of the elongated body 102. Upon actuation of the control valve, compressed air may enter the barrel 520 of the air cylinder 518 on one side of the piston 522 and exit on the other side of the barrel 520 to retract the piston 522 and piston rod 524 and thereby release the second end 105. The piston rod 524 may therefore function in a similar manner to the plunger 124 of the solenoid 118. The piston rod 524 of the air cylinder 518 could also be used in place of the plungers of the release mechanisms 206 and 406 of FIGS. 4A-4B and 6A-6B.

FIG. 7B shows an alternative use of the air cylinder 518 as a push mechanism, rather than as a release mechanism. In this embodiment, the air cylinder 518 is positioned vertically (i.e. perpendicular to the body 102) above the body 102 with the piston rod 524 directed downwards. In this position, actuation of the piston rod 524 will push the second end 105 of the elongated body 102 downwards.

In some embodiments, a combination of two or more release mechanisms may be employed such as a cable release or solenoid as the primary release mechanism and an air cylinder as a secondary failsafe release mechanism. For example, the vertical air cylinder arrangement of FIG. 7B could be used as a backup mechanism to push the body 102 downwards if the elongated body 102 is not released by one of the release mechanisms.

FIGS. 8A-8C are schematics showing the vehicle assembly 100 of FIG. 1 installed on an example vehicle 600, at various stages of deployment of the elongated body 102. Hereafter, the elongated body 102 will be referred to as the sand ladder 102. Note that the sand ladder 102 is not to scale with the vehicle 600 and portions have been enlarged for illustrative purposes.

The vehicle 600 has front wheels 602 and back wheels 604. Although only one side of the vehicle 600 is shown in FIGS. 8A-8C, with one vehicle assembly 100, it will be understood that a second vehicle assembly 100 may be installed on the other side of the vehicle 600 and be operable in a similar manner.

Referring to FIG. 8A, the vehicle assembly 100 may be installed on the vehicle 600 with the mounting assembly 104 proximate the front wheel 602 of the vehicle 600 and the release mechanism 106 proximate the back wheel 604. The sand ladder 102 is positioned such that its first end 103 engages the mounting track 116 (in the gap G, visible in FIG. 8C) and its back end 105 is held in place by the plunger 124 of the solenoid 118 in its extended position. When the sand ladder 102 is in place on the vehicle 600, it may provide underbody protection similar to a rock slider. The sand ladder 102 may also help to absorb side impact energy.

When the vehicle 600 drives over soft or uneven terrain such as mud or sand, the user may desire to deploy the sand ladder 102 to provide better traction and avoid getting stuck. Alternatively, the user may wish to deploy the sand ladder 102 on icy terrain to provide traction and act as a braking device. The user may activate the release mechanism 106 via the switch 128, causing the plunger 124 of the solenoid 118 to retract into its retracted position. As shown in FIG. 8B, the second end 105 of the sand ladder 102 is then released and starts to fall downwards toward the ground by the force of gravity due to the weight of the sand ladder 102. In embodiments with other types of release mechanisms, such as an air cylinder, the second end 105 of the sand ladder 102 may be pushed downwards.

As the vehicle 600 moves forward while the second end 105 of the sand ladder 102 falls (or is pushed) downwards, the first end 103 will slide out of the mounting track 116. The first end 103 will then fall downwards towards the ground, thereby fully releasing the sand ladder 102 from the vehicle 600. In some embodiments, the first end 103 may slide about 6-18 inches (e.g., 12 inches/one foot) before it falls, which allows the second end 105 to reach the rear wheel 404 before the first end 103 drops. However, it will be understood that the distance may vary depending on the size of the vehicle and length of the sand ladder 102. FIG. 8C shows the sand ladder 102 fully deployed with both the first and second ends 103, 105 on the ground and the second end 105 positioned under the rear wheel 604. The flanges 108 and 112 may dig into the ground to assist in securing the second end 105 and facilitate pulling the first end 103 out of the mounting track 116. In some embodiments, the teeth 117 at the bottom of the V-shaped ridges 109 and the second side edge 113 also dig into the ground.

As noted above, a second vehicle assembly 100 can be installed on the other side of the vehicle 600. In some embodiments, the switch 128 may be used to activate the respective solenoids 118 of both assemblies 100 such that both sand ladders 102 are deployed at substantially the same time. In other embodiments, each assembly 100 may have a separate switch 128 and the user can decide to deploy one or both sand ladders 102. In these embodiments, the two sand ladders 102 may be deployed at the same time or sequentially.

With the sand ladders 102 deployed, the vehicle 600 can drive forward such that the rear wheels 604 move onto the sand ladders 102. The vehicle 600 can then drive back and forth on the sand ladders 102 almost the full length of the wheelbase. A vehicle with four-wheel drive can drive twice the length of the wheelbase plus the length of the sand ladder 102. The user then has time to make a plan and determine how to avoid getting stuck. For example, the user could accelerate quickly in reverse such that the front wheels 602 move onto the sand ladders 102. Alternatively, the user could get out of the vehicle and move obstacles and/or shovel some of the mud or sand, etc. out of the way of the front wheels 602. Other actions could include airing down, chaining up, locking hubs, locking differentials and transfer case, scouting a trail ahead, calling for help, determining winch points, etc. In addition, if the vehicle 600 is driving through sand, deployment of the sand ladders 102 may allow the vehicle to stop and restart, which may otherwise be difficult to do.

In some embodiments, a second set of sand ladders (not shown) may be provided on either side of the vehicle 600 above the first set of sand ladders 102 of the vehicle assembly 100. In some embodiments, the second set of sand ladders are stored on their sides to protect the fuel tank of the vehicle 600. The second set of sand ladders could be deployed sequentially after the sand ladders 102 of the vehicle assembly 100 to allow the vehicle 600 to “leapfrog” over a difficult portion of terrain. The second set of sand ladders may be deployed manually or using some form of automatic deployment system.

Optionally, the vehicle assembly 100 may further comprise a tether (not shown) that connects the elongated body 102 to a portion of the vehicle. The tether may allow the elongated body 102 to remain attached to the vehicle 600 after it is deployed such that the elongated body 102 can be recovered and reloaded into the mounting assembly 104 once the vehicle 600 has moved past the difficult terrain.

Optionally, each sand ladder 102 may have a serial number (not shown) engraved or otherwise marked thereon. The serial number may allow the sand ladders 102 to be traced back to the vehicle owner if they are deployed and not picked up.

Thus, unlike conventional sand ladders that can only be deployed after a vehicle becomes stuck, embodiments of the vehicle assembly 100 allow the sand ladder 102 to be deployed prior to the vehicle 600 becoming stuck, while the wheels 602/604 are still able to turn. The sand ladder 102 may be automatically deployed in the proper position in line with the vehicle 600 wheels 602, 604 without requiring the user to exit the vehicle 600 and manually position the sand ladder 102. The assembly 100 may also allow sand ladders 102 on both sides of the vehicle to be deployed at the same time, which can facilitate both rear wheels 604 gaining traction. The user can thereby quickly and easily move the vehicle 600 through difficult terrain without getting stuck.

Although FIGS. 8A-8C only show the vehicle assembly 100 with the release mechanism 106, it will be understood that the vehicle assembly 100 may be operated in a similar manner with the release mechanism 206, 306, 406, 506, or any of the other release mechanism embodiments discussed above or any combination thereof.

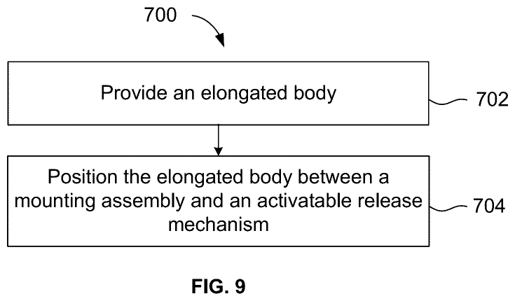

FIG. 9 is a flowchart of an example method 700 for assembling a vehicle assembly, according to some embodiments. The method 700 may be used to assemble the vehicle assembly 100.

At block 702, an elongated body is provided. The term “provide” in this context refers to making, manufacturing, acquiring, purchasing, or otherwise obtaining the elongated body. The elongated body may have any of the features of the elongated body 102 of the assembly 100 as discussed above. The elongated body has a first end and a second end.

At block 704, the elongated body is positioned between a mounting assembly and an activatable release mechanism. The mounting assembly and the release mechanism may have any of the features of the mounting assembly 104 and the release mechanism 106, 206, 306, 406, or 506 of the assembly 100 as discussed above. In some embodiments, the mounting assembly and the release mechanism may be mounted to the underside of a vehicle first and the elongated body may then be positioned therebetween. In some embodiments, the mounting assembly comprises a mounting track and the first end of the elongated body may be positioned on the mounting track. The elongated body may be positioned approximately parallel to the underside of the vehicle.

The release mechanism may comprise a retractable element moveable between an extended position and a retracted position. The second end of the elongated body may thereby be positioned on the retractable element in the extended position. For example, in some embodiments, the release mechanism may comprise a solenoid with a moveable plunger and the second end of the elongated body may be positioned on the plunger (or on a support block connected to the plunger). In other embodiments, the release mechanism may comprise any other embodiments of the release mechanisms discussed above. In other embodiments, a push mechanism may be used instead of (or in addition to) a release mechanism. The push mechanism may comprise an air cylinder above and perpendicular to the elongated body with the piston rod directed downwards to push the elongated body down when activated. In the latter embodiment, the piston rod may be initially in its retracted position and then extended to push the elongated body downwards.

In some embodiments, the method 700 may further comprise electrically connecting a switch to the release mechanism and to a power source. In these embodiments, the method 700 further comprises mounting the switch in the interior of the vehicle, such as on the dash.

In some embodiments, the method 700 may comprise providing a second elongated body and positioning the second elongated body between a second mounting assembly and a second release mechanism. The method 700 may further comprise electrically connecting a switch to the second release mechanism. The switch may be the same switch as is connected to the first release mechanism. In some embodiments, a mechanical linkage could be used to operate both the release mechanisms with a single solenoid (or air cylinder, cable release, etc.).

Also provided herein is a kit comprising the vehicle assembly 100. The kit may comprise a first vehicle assembly 100 and a second vehicle assembly 100. The kit may further comprise a switch electrically connectable to the release mechanisms 106/206/306/406/506 of the first and second vehicle assemblies 100. The kit may also include wires for connecting the assemblies 100 to the switch. In some embodiments, the kit may further comprise instructions for installing the assemblies on a vehicle, with one assembly 100 on one side of the vehicle and the other assembly on the other side of the vehicle. In some embodiments, the instructions may further instruct the user how to mount the switch in the cab of the vehicle, such as on the dash. In some embodiments, the kit further comprises a tether to attach each elongated body 102 to the vehicle and allow the elongated body 102 to be recovered after it is deployed. In some embodiments, the kit further comprises a retention mechanism (e.g. a pin/handle) for securing the body 102 to the vehicle and to assist in reloading the elongated body 102 100 back onto the vehicle. In some embodiments, the kit may further comprise a U-shaped rod for linking more than one elongated body 102 together as discussed above.

Although a few embodiments have been shown and described, it will be appreciated by those skilled in the art that various changes and modifications can be made to those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof.

1. A vehicle assembly comprising:
an elongated body having a first end and a second end;
a mounting assembly comprising:
a mounting base connectable to an underside of a vehicle; and
a mounting track extending from the mounting base, the mounting track supporting the first end of the elongated body; and
an activatable release mechanism connectable to the underside of the vehicle, the release mechanism releasably engaging the second end of the elongated body;
wherein activation of the release mechanism releases the second end of the elongated body, and wherein release of the second end allows the first end to slide out of the mounting track to release the elongated body from the vehicle.

2. The vehicle assembly of claim 1, wherein the release mechanism comprises a retractable element, the retractable element moveable between an extended position and a retracted position.

3. The vehicle assembly of claim 2, wherein the release mechanism comprises a solenoid and the retractable element comprises a moveable magnetic plunger within a coiled wire, the plunger being moveable by application of electrical current to the coiled wire.

4. The vehicle assembly of claim 3, wherein the release mechanism further comprises a support block coupled to a distal end of the plunger.

5. The vehicle assembly of claim 2, wherein the release mechanism comprises a cable release and the retractable element comprises a retractable cable coupled to a support block.

6. The vehicle assembly of claim 4, further comprising:
a secondary support block positioned below the support block; and/or
a rear mount structure slidably engaged with the support block.

7. The vehicle assembly of claim 2, wherein the retractable element comprises a tab coupled to a moveable plunger therebelow and a rotatable cylindrical rod extending downwards from the tab adjacent to the moveable plunger, wherein linear movement of the moveable plunger rotates the rotatable cylindrical rod, thereby rotating the tab.

8. The vehicle assembly of claim 2, wherein the release mechanism comprises a pneumatic air cylinder and the retractable element comprises a moveable piston and a piston rod within a barrel, the piston and piston rod moveable by application of compressed air into the barrel.

9. The vehicle assembly of claim 8, wherein the pneumatic air cylinder is positioned parallel to the elongated body such that the piston rod extends below the elongated body.

10. The vehicle assembly of claim 1, further comprising a push mechanism, wherein the push mechanism comprises a pneumatic air cylinder that is positioned above and perpendicular to the elongated body such that the piston rod extends downwards towards the elongated body.

11. The vehicle assembly of claim 1, wherein the elongated body comprises a recessed portion that at least partially receives the release mechanism.

12. The vehicle assembly of claim 1, further comprising a first flange at the first end of the elongated body, the first flange being perpendicular to the elongated body and extending downwards therefrom.

13. The vehicle assembly of claim 12, further comprising a second flange at the second end of the elongated body, the second flange being perpendicular to the elongated body and extending downwards therefrom.

14. The vehicle assembly of claim 1, wherein the elongated body comprises a horizontal portion and one or more V-shaped ridges extending downwards from the horizontal portion.

15. The vehicle assembly of claim 1, further comprising a switch electrically connected to the release mechanism and a power source.

16. The vehicle assembly of claim 15, wherein the switch is positionable in the interior of the vehicle.

17. A kit comprising:
a first vehicle assembly and a second vehicle assembly, wherein each of the first and second assemblies comprises:
an elongated body having a first end and a second end;
a mounting assembly comprising:
a mounting base connectable to an underside of a vehicle; and
a mounting track extending from the mounting base, the mounting track supporting the first end of the elongated body; and
an activatable release mechanism connectable to the underside of the vehicle, the release mechanism releasably engaging the second end of the elongated body;
wherein activation of the release mechanism releases the second end of the elongated body, and wherein release of the second end allows the first end to slide out of the mounting track to release the elongated body from the vehicle; and
a switch electrically connectable to the respective release mechanisms of the first vehicle assembly and the second vehicle assembly.

18. The kit of claim 17, further comprising at least one pin or handle for engaging the elongated body of each of the first and second vehicle assemblies.

19. A method for assembling a vehicle assembly, comprising:
providing an elongated body with a first end and a second end; and
positioning the elongated body between a mounting assembly at the first end and an activatable release mechanism at the second end.

20. The method of claim 19, wherein the release mechanism comprises a retractable element, the retractable element moveable between an extended position and a retracted position; and wherein the second end of the elongated body is positioned on the retractable element in the extended position.
